(19) United States
(12) Patent Application Publication
(10) Pub. No.: US 2009/0139145 A1
(43) Pub. Date: Jun. 4, 2009

(54) Door and rack

(75) Inventors: Takashi Watanabe, Kawasaki (JP); Satoru Yamada, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/285,237

(22) Filed: Sep. 30, 2008

(30) Foreign Application Priority Data
Nov. 30, 2007 (JP) 2007-310912

(51) Int. Cl. E05D 15/50; E05F 11/24

(52) U.S. Cl. 49/193; 49/339

(57) ABSTRACT

A door includes a door body, a pair of rotating shafts, a pair of opening/closing levers and an inhibiting member. The pair of rotating shafts rotate the door body toward either one of the left and right directions. The pair of rotating shafts are provided on each of the left and right sides of the door body. The pair of rotating shafts are vertically slidable. The pair of opening/closing levers are provided on each of the left and right sides of the door body. The opening/closing lever is connected to the rotating shaft on the same side of the door body. The opening/closing lever acommodates the connected rotating shaft within the door body by rotation. The inhibiting member inhibits one of the rotating shafts from being accommodated within the door body by operating simultaneously with rotation of the opening/closing lever connected to the other rotating shaft.

### BACKGROUND OF THE INVENTION

1. Field of the Invention

The present invention relates to an opening/closing mechanism of a door in a disk array device or the like.

2. Description of the Related Art

The disk array device mounts hard disks or the like constituting redundant array of inexpensive disks (RAID) inside a rack. When performing maintenance of the disk array device, such as replacement of a hard disk, opening/closing of the door is needed. In general, the door is configured to be opened or closed only from either one of the left and right sides.

When attempting to install a disk array device, a user has hitherto needed to determine where the device to be positioned in accordance with an opening/closing direction of the door. There is, therefore, a demand for a disk array device having a door that can be opened/closed from both the left and right sides.

### SUMMARY

It is an object of the present invention to provide a door that can be opened/closed from both of the left and right sides, and a rack.

According to an aspect of an embodiment, a door is for opening/closing a rack body accommodating an electronic device. The rack includes the rack body, and the door for opening/closing a rack body, the door being engaged with the rack body at predetermined positions.

The door includes a door body, a pair of rotating shafts, a pair of opening/closing levers and an inhibiting member. The pair of rotating shafts rotate the door body toward either one of the left and right directions. The pair of rotating shafts are provided on each of the left and right sides of the door body. The pair of rotating shafts are vertically slidable. The pair of opening/closing levers are provided on each of the left and right sides of the door body. The opening/closing lever is connected to the rotating shaft on the same side of the door body. The opening/closing lever acommodates the connected rotating shaft within the door body by rotation. The inhibiting member inhibits one of the rotating shafts from being accommodated within the door body by operating simultaneously with rotation of the opening/closing lever connected to the other rotating shaft.

### BRIEF DESCRIPTION OF THE DRAWINGS

FIG. 1 is a perspective view of a rack according to a first embodiment;

FIGS. 2A and 2B are diagrams each showing an opened state of a door of the rack according to the first embodiment;

FIGS. 3A and 3B are diagrams each showing an opening/closing mechanism of the door according to the first embodiment;

FIG. 4 is a diagram of a locking mechanism of an opening/closing lever of the door according to the first embodiment;

FIG. 5 is a diagram of a closed state of the door according to the first embodiment;

FIGS. 6A and 6B are explanatory diagrams (1) of operations when the door according to the first embodiment is to be opened from the left side;

FIG. 7 is an explanatory diagram (2) of operations when the door according to the first embodiment is to be opened from the left side;

FIG. 8 is a diagram of operations when the door according to the first embodiment is to be opened from the right side;

FIG. 9 is a diagram of an opening/closing mechanism of the door according to a second embodiment of the present invention;

FIG. 10 is a diagram of a closed state of the door according to the second embodiment;

FIG. 11 is a diagram of operations when the door according to the second embodiment is to be opened from the left side; and

FIG. 12 is a diagram of operations when the door according to the second embodiment is to be opened from the right side.

### DESCRIPTION OF THE PREFERRED EMBODIMENTS

### First Embodiment

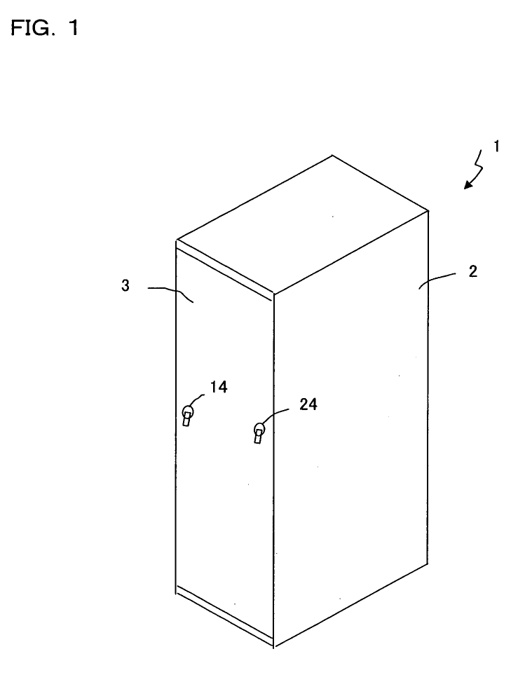

FIG. 1 is a perspective view of a rack according to a first embodiment.

The rack 1 includes a rack body 2 and a door 3. The rack 1 is, for example, one used for disk array device, and mounts a plurality of hard disks constituting RAIDs in the rack body 2.

The door 3 has opening/closing levers 14 and 24 for opening/closing the door 3, the opening/closing levers 14 and 24 being located on the left and right sides of the door 3 in the front of the rack 1, and in the neighborhood of a heightwise center of the door 3. The opening/closing levers 14 and 24 in FIG. 1 are each in a stopping state.

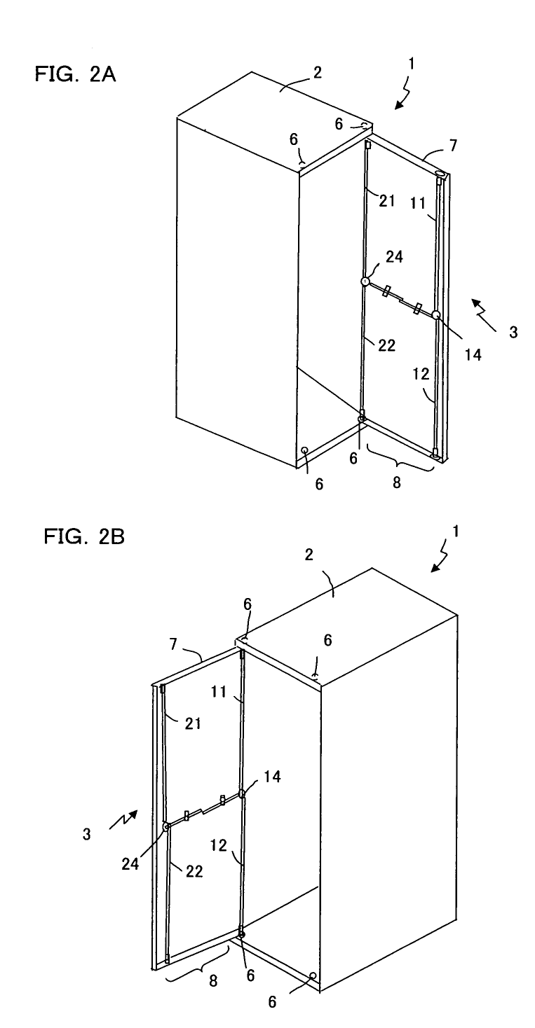

FIG. 2A and 2B are diagrams each showing an opened state of the door of the rack according to the first embodiment. The rack body 2 has four bearing section 6 for being engaged with the door 3. The door 3 includes also a door body 7 and an opening/closing mechanism 8.

When an operator rotates clockwise the opening/closing lever 14 shown in FIG. 1, and pulls it forward, the door 3 is opened from the left side. FIG. 2A shows a state where the door 3 is opened from the left side.

On the other hand, when the operator rotates clockwise the opening/closing lever 24 shown in FIG. 1, and pulls it forward, the door 3 is opened from the right side. FIG. 2B shows a state where the door 3 is opened from the right side.

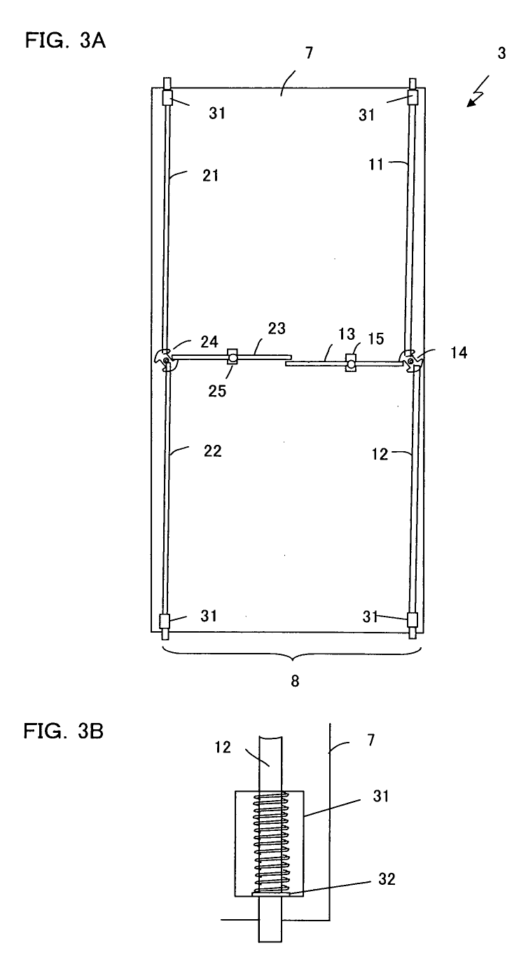

FIGS. 3A and 3B are diagrams each showing an opening/closing mechanism of the door according to the first embodiment. FIG. 3A is a rear view of the door 3.

Each of the upward-downward direction, left-right direction, and rotational direction denotes a direction as viewed from the plan of the rear view of the door 3 shown in FIG. 3. Directions as viewed from the operator side, that is, from the front side of the door 3, will be described on an individual basis.

In the door body 7, the opening/closing mechanism 8 includes rotating shafts 11 and 12 on the right side, a rotation lock bar 13 on the right side, an opening/closing lever 14 on the right side, and a rotation support section 15 on the right side. Furthermore, in the door body 7, the opening/closing mechanism 8 includes rotating shafts 21 and 22 on the left side, a rotation lock bar 23 on the left side, an opening/closing lever 24 on the left side, and a rotation support section 25 on the left side.

The rotating shafts 11 and 12, respectively, are provided upward and downward on the right side in the door body 7. The rotating shafts 11 and 12 are connected to the opening/closing lever 14.

As shown in FIG. 2A, when the door 3 of the rack 1 is opened from the left side as viewed from the operator, the rotating shafts 11 and 12, respectively, move downward and upward so as to be disengaged from the rack body 2 and accommodated within the door body 7. On the other hand, as shown in FIG. 2B, when the door 3 of the rack 1 is opened from the right side as viewed from the operator, the rotating shafts 11 and 12 serve as a shaft for rotating the door 3.

The rotating shafts 21 and 22, respectively, are provided upward and downward on the left side in the door body 7. The rotating shafts 21 and 22 are connected to the opening/closing lever 24.

As shown in FIG. 2B, when the door 3 is opened from the right side as viewed from the operator, the rotating shafts 21 and 22, respectively, move downward and upward so as to be disengaged from the rack body 2 and accommodated within the door body 7. As shown in FIG. 2A, when the door 3 is opened from the left side as viewed from the operator, the rotating shafts 21 and 22 serve as a shaft for rotating the door 3.

The rotation lock bar 13 is provided on the right side in the door body 7. One end of the rotation lock bar 13 is disposed adjacently along the rotational direction of the opening/closing lever 14, and the other end thereof is disposed adjacently to the rotation lock bar 23. When the one end of the rotation lock bar 13 is depressed by counterclockwise rotation of the opening/closing lever 14, it rotates clockwise around the rotation support section 15. Under this rotation, the other end of the rotation lock bar 13 makes contact with the rotation lock bar 23. As a result, the rotation lock bar 13 inhibits the rotation lock bar 23 from clockwise rotation.

The rotation lock bar 23 is provided on the left side in the door body 7. One end of the rotation lock bar 23 is disposed adjacently along the rotational direction of the opening/closing lever 24, and the other end thereof is disposed adjacently to the rotation lock bar 13. When the one end of the rotation lock bar 23 is pushed up by counterclockwise rotation of the opening/closing lever 24, it rotates clockwise around the rotation support section 25. Under this rotation, the one end of the rotation lock bar 23 makes contact with the rotation lock bar 13. As a result, the rotation lock bar 23 inhibits the rotation lock bar 13 from clockwise rotating.

The opening/closing lever 14 is provided on the right side in the door body 7. By rotating counterclockwise from the stoppage position to a predetermined position, the opening/closing lever 14 moves the rotating shaft 11 downward and moves the rotating shaft 12 upward, to thereby release engagement between the rack body 2 and the respective bearing sections 6, and accommodate the rotating shafts 11 and 12 within the door body 7. When the operator pulls forward the opening/closing lever 14, the door body 7 can be opened from the left side as viewed from the operator side. The opening/closing lever 14 also depresses the rotation lock bar 13.

The opening/closing lever 14 has a lock mechanism. When the opening/closing lever 14 rotates counterclockwise and performs locking operation at a prediction position, the rotation lock bar 13 and the rotating shafts 11 and 12 are locked together.

When the door is to be closed, the operator accommodates the door 3 within the rack body 2, and then returns the opening/closing lever 14 to the stoppage position. As a consequence, the rotating shaft 11 connected to the opening/closing lever 14 moves upward, and the rotating shaft 12 connected thereto moves downward, whereby they are engaged with the respective bearing sections 6 in the rack body 2.

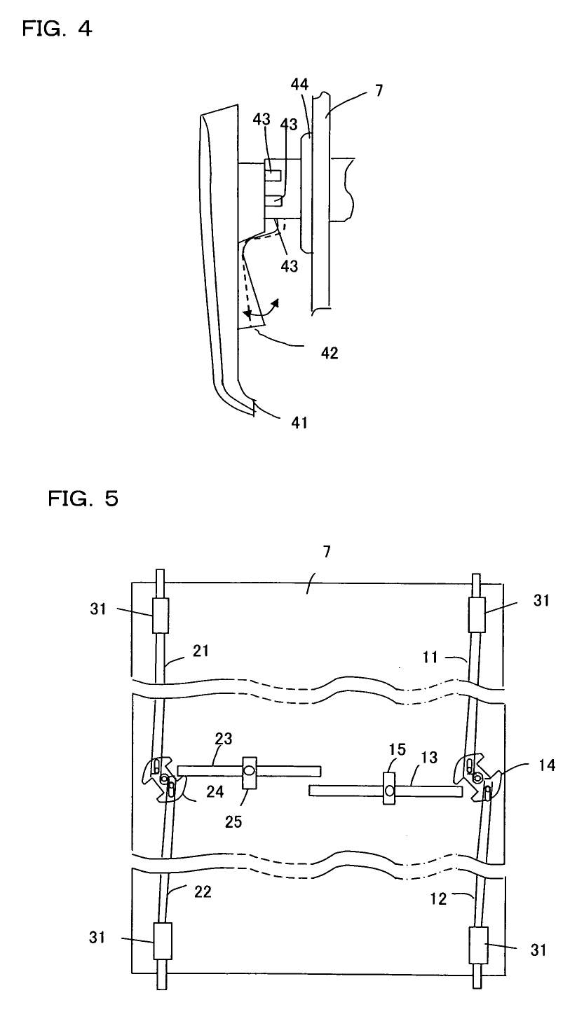

FIG. 4 is a diagram of a locking mechanism of an opening/closing lever of the door according to the first embodiment. And FIG. 4 shows a well-known example of the locking mechanism.

The locking mechanism of the opening/closing lever 14 is constituted by a lock lever 42 provided on a handle 41, and grooves 43 in a flange section 44 provided in the door body 7.

When a front end of the lock lever 42 is engaged with the grooves 43, rotation of the handle 41 is locked. On the other hand, when the lock lever 42 is depressed and the engagement between the front end and the grooves 43 is released, rotation of the handle 41 is unlocked. Broken line regarding the lock lever 42 in FIG. 4 shows a state where the rotation is unlocked, while a solid line shows a state where the rotation is locked.

Now, operations of the opening/closing lever 14 will be described.

In order to open the door 3, firstly in the stoppage position, when the operator grasps the handle 41 while depressing the lock lever 42, lock is released. In this state, when the operator rotates the handle 41 in the clockwise direction as viewed from the operator side from the stoppage position to a predetermined position, and then releases the lock lever 42, the front end of the lock lever 42 is engaged with the grooves 43 in the flange section 44, and the handle 41 is locked. Now this is a state allowing the door 3 to be opened.

On the other hand, in order to close the door 3, the operator grasps the handle 41 while depressing the lock lever 42, and rotates back the handle 41 in the counterclockwise direction as viewed from the operator from the predetermined position to the stoppage position. Then, upon releasing the lock lever 42, the front end of the lock lever 42 is engaged with the grooves 43 in the flange section 44, and the handle 41 is locked.

Now, description is returned to the explanation with reference to FIG. 3.

The opening/closing lever 24 is provided on the left side in the door body 7. By rotating counterclockwise from the stoppage position to the predetermined position, the opening/closing lever 24 moves the rotating shaft 21 downward and moves the rotating shaft 22 upward, to thereby release engagement between the rack body 2 and the respective bearing sections 6, and accommodate the rotating shafts 21 and 22 within the door body 7. When the operator pulls forward the opening/closing lever 24, the door body 7 can be opened from the right side as viewed from the operator side. The opening/closing lever 24 also pushes up the rotation lock bar 23.

The opening/closing lever 24 has a lock mechanism. When the opening/closing lever 24 rotates counterclockwise and performs locking operation at a prediction position, the rotating shafts 21 and 22 and the rotation lock bar 23 are locked together.

When the door is to be closed, the operator accommodates the door 3 within the rack body 2, and then returns the opening/closing lever 24 to the stoppage position. As a consequence, the rotating shaft 21 connected to the opening/closing lever 24 moves upward, and the rotating shaft 22 connected thereto moves downward, whereby they are engaged with the respective bearing sections 6 in the rack body 2. The locking mechanism of the opening/closing lever 24 is the same as that of the opening/closing lever 14.

The rotation support section 15 is a support section for supporting the rotation lock bar 13, while the rotation support section 25 is a support section for supporting the rotation lock bar 23. The rotation support section 15 and the rotation support section 25 each has a spring. When the rotation lock bar 13 or the rotation lock bar 23 rotates clockwise, the spring is compressed. As a result, when the opening/closing levers 14 and 24 clockwise rotate and return to the stoppage position, the rotation support sections 15 and 25 returns to the original stoppage position.

FIG. 3B is a diagram of a spring section 31. FIG. 3B shows an example of spring section 31 in which the rotating shaft 12 is arranged. Spring sections 31 in which the other rotating shafts 11, 21, and 22 are arranged, have the same structure as the spring section 31 in which the rotating shaft 12 is arranged. The spring sections 31 are fixed to the door body 7, and they each incorporate a spring. Each of the rotating shafts 11, 12, 21, and 22 is arranged in a spring.

When the door 3 is in a closed state and the rotating shafts 11 and 12, and the rotating shafts 21 and 22 are engaged with the respective bearing sections 6 in the rack body 2, the springs are each in an uncompressed state.

On the other hand, when the rotating shafts 11 and 12 are accommodated within the door body 7 by counterclockwise rotation of the opening/closing lever 14, or when the rotating shafts 21 and 22 are accommodated within the door body 7 by counterclockwise rotation of the opening/closing lever 24, the compression section 32 connected to each of the rotating shafts 11 and 12, or the compression section 32 connected to each of the rotating shafts 21 and 22 compresses the spring.

When the opening/closing lever 14 returns to the stoppage position by its clockwise rotation, the rotating shafts 11 and 12 are engaged with the respective bearing sections 6 in the rack body 2 by restoring forces of the respective springs. Likewise, when the opening/closing lever 24 returns to the stoppage position by its clockwise rotation, the rotating shafts 21 and 22 are engaged with the respective bearing section 6 in the rack body 2, by restoring forces of the respective springs.

### (Description of Opening/Closing Operations)

FIG. 5 is a diagram of a closed state of the door according to the first embodiment. FIG. 5 illustrates the case where the rotating shafts 11, 12, 21, and 22 have jumped out from the door body 7 to thereby be inserted into the respective bearing section 6 in the rack body 2. The rotation lock bars 13 and 23 remain apart from each other at a predetermined distance without making contact with each other. The opening/closing lever 14 and the opening/closing lever 24 are each located in the stoppage position.

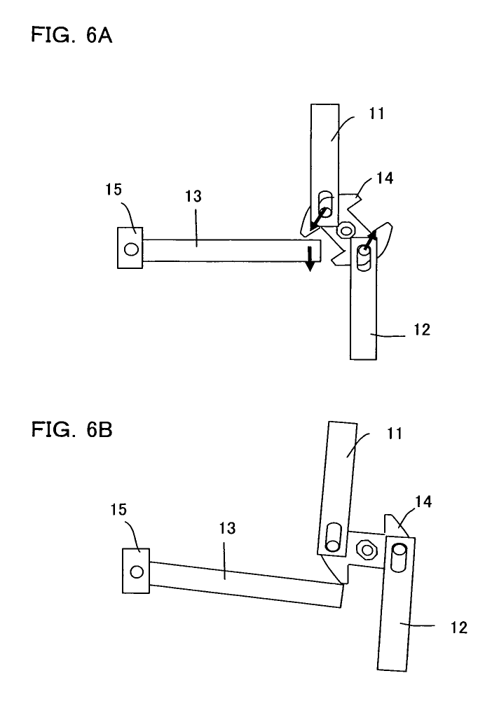

FIGS. 6A and 6B are explanatory diagrams (1) of operations when the door according to the first embodiment is to be opened from the left side as viewed from the operator.

These diagrams illustrate the case where the door is opened from the left side as viewed from the operator. FIGS. 6A and 6B are each a diagram as viewed from the rear surface of the door body 7. Here, FIG. 6A shows the opening/closing lever 14 located in the stoppage position, the rotating shafts 11 and 12, the rotation lock bar 13, and the rotation support section 15.

In FIG. 6A, a state before the opening/closing lever 14 rotates counterclockwise is illustrated. Arrows in FIG. 6A indicate a counterclockwise moving direction. This corresponds to the case where, in order to open the door from the left side, the operator rotates the opening/closing lever 14 in the clockwise direction as viewed from the operator.

On the other hand, FIG. 6B illustrates a state after the opening/closing lever 14 has rotated counterclockwise. By this rotation, the opening/closing lever 14 moves downward the rotating shaft 11 connected thereto, and moves upward the connected rotating shaft 12 connected thereto. As a result, the rotating shaft 11 is disengaged from the bearing section 6 in the rack body 2. The rotating shaft 12 is also disengaged from the bearing section 6 in the rack body 2.

Simultaneously, the opening/closing lever 14 depresses one end of the rotation lock bar 13. The one end of the rotation lock bar 13 is adjacent to the opening/closing lever 14. As a consequence, the rotation lock bar 13 rotates clockwise around the rotation support section 15.

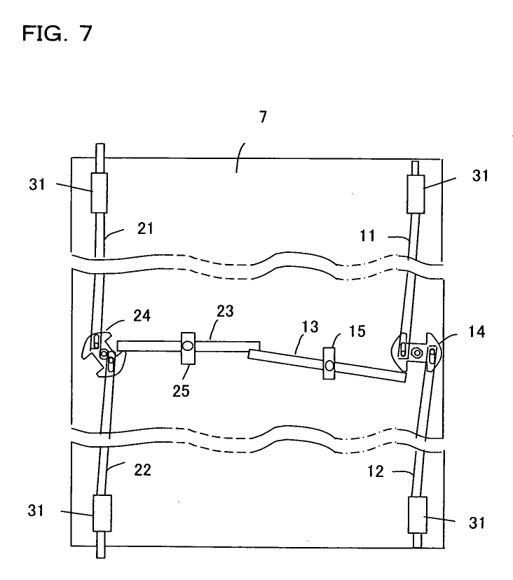

FIG. 7 is an explanatory diagram (2) of operations when the door according to the first embodiment is to be opened from the left side as viewed from the operator.

By the rotation of the rotation lock bar 13, the other end of the rotation lock bar 13 makes contact with the rotation lock bar 23. The other end of the rotation lock bar 13 is adjacent to the rotation lock bar 23. Since the opening/closing lever 14 is in a state of being locked by the rotation, the rotation lock bar 13 cannot make counterclockwise rotation.

As a result, the rotation lock bar 23 is inhibited from clockwise rotation by the rotation lock bar 13, so that the opening/closing lever 24 connected to the rotation lock bar 23 is inhibited from counterclockwise rotation. Consequently, the rotating shafts 21 and 22 remain engaged with the rack body 2, and so they serve as a shaft for rotating the door 3. Hence, when the operator pulls forward the opening/closing lever 14, the door 3 opens from the left side as viewed from the operator.

Next, description is made of operations when the door 3 that has been opened from the left side is to be closed.

First, the operator rotates the door 3 and accommodates it within the rack body 2. Then, the operator rotates the opening/closing lever 14 in the counterclockwise direction as viewed from the operator. By this rotation, the opening/closing lever 14 moves upward the rotating shaft 11 connected thereto, and moves downward the rotating shaft 12 connected thereto. As a result, the rotating shaft 11 is inserted into the bearing section 6 in the rack body 2. The rotating shaft 12 is also inserted into the bearing section 6 in the rack body 2.

Simultaneously, the opening/closing lever 14 releases the rotation lock bar 13 from the depressed state. Consequently, the rotation lock bar 13 rotates counterclockwise around the rotation support section 15, and returns to the stoppage position. By the rotation of the rotation lock bar 13, the end of the rotation lock bar 13 is detached from the rotation lock bar 23. In this manner, the rotation lock bar 23 is released from the inhibition by the rotation lock bar 13. This results in a state where the door 3 is closed to the rack body 2.

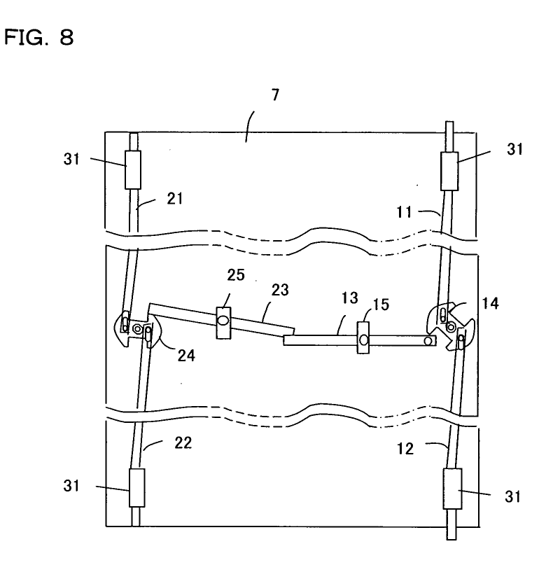

FIG. 8 is a diagram of operations when the door according to the first embodiment is to be opened from the right side as viewed from the operator.

First, in the state shown in FIG. 5, the opening/closing lever 24 is rotated counterclockwise.

By this rotation, the opening/closing lever 24 moves downward the rotating shaft 21 connected thereto, and moves upward the rotating shaft 22 connected thereto. As a result, the rotating shaft 21 is disengaged from the bearing section 6 in the rack body 2. The rotating shaft 22 is also disengaged from the bearing section 6 in the rack body 2.

Simultaneously, the opening/closing lever 24 pushes up one end of the rotation lock bar 23. The one end of the rotation lock bar 23 is adjacent to the opening/closing lever 24. As a consequence, the rotation lock bar 23 rotates clockwise around the rotation support section 25. By the rotation of the rotation lock bar 23, the other end of the rotation lock bar 23 makes contact with the rotation lock bar 13. The other end of the rotation lock bar 23 is adjacent to the rotation lock bar 13. The opening/closing lever 24 is in a state of being locked by the rotation. Consequently, the rotation lock bar 13 is inhibited from clockwise rotation by the rotation lock bar 23, so that the opening/closing lever 14 connected thereto is inhibited from rotation. As a result, the rotating shafts 11 and 12 remain engaged with the rack body 2, and so they serve as a shaft for rotating the door 3. Hence, when the operator pulls forward the opening/closing lever 24, the door 3 opens from the right side as viewed from the operator.

Now, description is made of operations when the door 3 that has been opened from the right side is to be closed.

First, the operator rotates the door 3 and accommodates it within the rack body 2. Then, the operator rotates the opening/closing lever 24 in the counterclockwise direction as viewed from the operator.

By this rotation, the opening/closing lever 24 moves upward the rotating shaft 21 connected thereto, and moves downward the rotating shaft 22 connected thereto. As a result, the rotating shaft 21 is inserted into the bearing section 6 in the rack body 2. The rotating shaft 22 is also inserted into the bearing section 6 in the rack body 2.

Simultaneously, the opening/closing lever 24 releases the rotation lock bar 23 from the pushed-up state. Consequently, the rotation lock bar 23 rotates counterclockwise around the rotation support section 25, and returns to the stoppage position. By the rotation of the rotation lock bar 23, the end of the rotation lock bar 13 is detached from the rotation lock bar 23. In this way, the rotation lock bar 13 is released from the inhibition by the rotation lock bar 23. This results in a state where the door 3 is closed to the rack body 2.

In each of the ends of the rotating shafts 11, 12, 21, and 22, there is provided a spring section 31, and when these rotating shafts are each accommodated within the door body 7, the spring section 31 is arranged to be compressed by the compression section 32. So, when the opening/closing lever 14 or the opening/closing lever 24 is returned to the stoppage position, the rotating shafts 11, 12, 21, and 22 are allowed to easily jump out from the door body 7.

### Second Embodiment

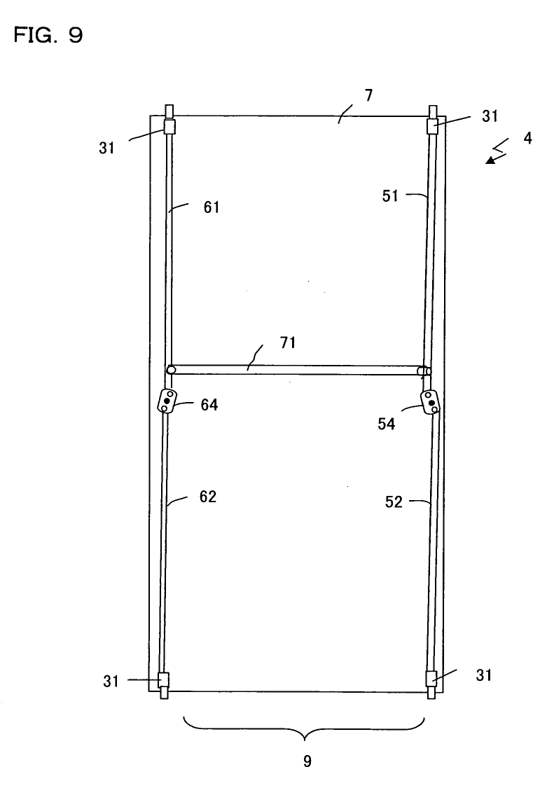

FIG. 9 is a diagram of an opening/closing mechanism of the door according to a second embodiment of the present invention.

FIG. 9 illustrates an outline of rear view of a door 4. The rack according to the second embodiment corresponds to one in which the door 3 in the rack 1 in FIG. 1 (perspective view) is replaced with a door 4; the opening/closing lever 14 is replaced with an opening/closing lever 54; and the opening/closing lever 24 is replaced with an opening/closing lever 64.

Each of the upward-downward direction, left-right direction, and rotational direction denotes a direction as viewed from the plan of the rear view of the door 4 shown in FIG. 9. Directions as viewed from the operator side, that is, from the front side of the door 4 will be described on an individual basis.

The opening/closing mechanism 9 includes rotating shafts 51 and 52 on the right side, and an opening/closing lever 54 on the right side. The opening/closing mechanism 9 also includes rotating shafts 61 and 62 on the left side, and an opening/closing lever 64 on the right side. Besides, the opening/closing mechanism 9 has a lock bar 71.

The second embodiment is different from the first embodiment in that the lock bar 71 is used instead of the rotation lock bars 13 and 23 in the first embodiment, and in that an opening/closing direction of the opening/closing lever 54 is opposite to that of the opening/closing lever 64.

When the door 4 is to be opened from the left side as viewed from the operator, the rotating shafts 51 and 52, respectively, move downward and upward so as to be disengaged from the rack body 2. On the other hand, when the door 4 is to be opened from the right side as viewed from the operator, the rotating shafts 51 and 52 serve as a shaft for rotating the door 4. The rotating shafts 51 and 52 are connected to the opening/closing lever 54.

When the door 4 is to be opened from the right side as viewed from the operator, the rotating shafts 61 and 62, respectively, move downward and upward so as to be disengaged from the rack body 2. On the other hand, when the door 4 is to be opened from the left side as viewed from the operator, the rotating shafts 61 and 62 serve as a shaft for rotating the door 4. The rotating shafts 61 and 62 are connected to the opening/closing lever 64.

As shown in FIG. 9, the opening/closing lever 54 is provided on the right side in the door body 7. By rotating counterclockwise from the stoppage position to a predetermined position, the opening/closing lever 14 moves the rotating shaft 51 downward and moves the rotating shaft 52 upward, to thereby release engagement between the rack body 2 and the respective bearing sections 6, and accommodate the rotating shafts 51 and 52 within the door body 7. When the operator pulls forward the opening/closing lever 54, the door body 7 can be opened from the left side as viewed from the operator side.

At this time, the opening/closing lever 54 depresses the rotation lock bar 71. The opening/closing lever 54 has also a lock mechanism. Hence, when the opening/closing lever 54 rotates counterclockwise and performs locking operation at a prediction position, the rotation lock bar 71 and the rotating shafts 51 and 52 are locked together.

When the door 4 is to be closed, the operator accommodates the door 4 within the rack body 2, and then returns the opening/closing lever 54 to the stoppage position. As a consequence, the rotating shaft 51 connected to the opening/closing lever 54 moves upward, and the rotating shaft 52 connected thereto moves downward, whereby they are engaged with the respective bearing sections 6 in the rack body 2.

The locking mechanism of the opening/closing lever 54 is the same as that of the opening/closing lever 14 in the first embodiment. As shown in FIG. 9, the opening/closing lever 64 is provided on the left side in the door body 7. By rotating clockwise from the stoppage position, the opening/closing lever 64 moves the rotating shaft 61 downward and moves the rotating shaft 62 upward, to thereby release engagement between the rack body 2 and the respective bearing sections 6, and accommodate the rotating shafts 61 and 62 within the door body 7. When the operator pulls forward the opening/closing lever 64, the door body 7 can be opened from the right side as viewed from the operator side. At this time, the opening/closing lever 64 depresses the rotation lock bar 71 by its rotation.

The opening/closing lever 64 has a lock mechanism. Hence, when the opening/closing lever 64 rotates clockwise and performs locking operation at a prediction position, the lock bar 71 and the rotating shafts 61 and 62 are locked together.

When the door is to be closed, the operator accommodates the door 4 within the rack body 2, and then returns the opening/closing lever 64 to the stoppage position. As a consequence, the rotating shaft 61 connected to the opening/closing lever 64 moves upward, and the rotating shaft 62 connected thereto moves downward, whereby they are engaged with the respective bearing sections 6 in the rack body 2. The locking mechanism of the opening/closing lever 64 is the same as that of the opening/closing lever 14.

The lock bar 71 is connected to the rotating shaft 51 and the rotating shaft 52. When the opening/closing lever 54 rotates counterclockwise, the lock bar 71 inhibits the opening/closing lever 64 from rotating. On the other hand, when the opening/closing lever 64 rotates clockwise, the lock bar 71 inhibits the opening/closing lever 54 from rotating.

### (Description of Opening/Closing Operations)

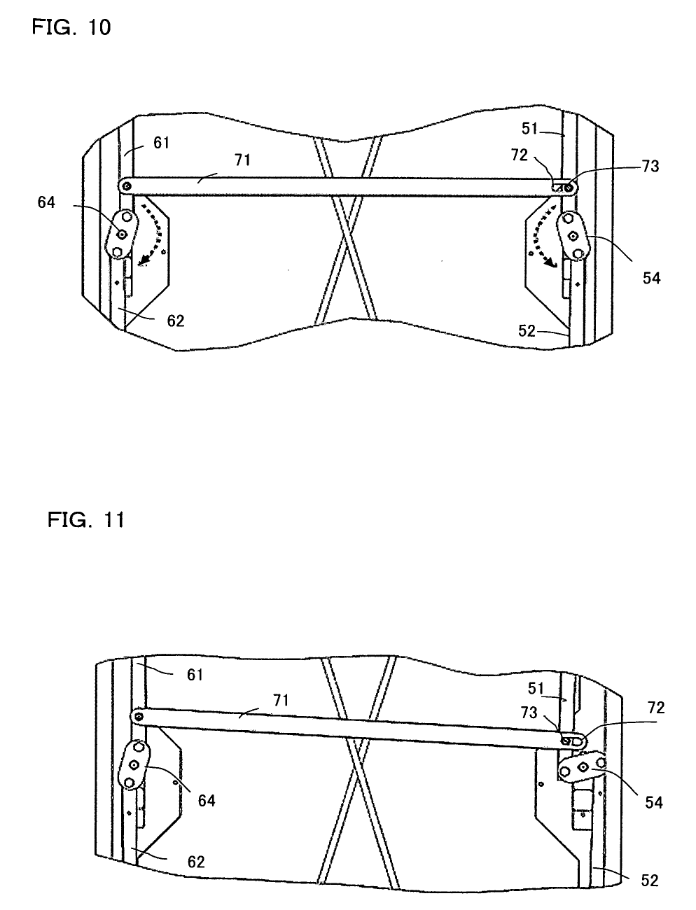

FIG. 10 is a diagram of a closed state of the door according to the second embodiment, wherein a state where the door 4 is closed and accommodated within the rack body 2, is illustrated. FIG. 10 shows the case where rotating shafts 51, 52, 61, and 62 have jumped out from the door body 7 to thereby be inserted into the respective bearing sections 6 in the rack body 2. Here, the rotation lock bars 71, and opening/closing lever 54 and 64 are located in the stoppage position.

FIG. 11 shows operations when the door according to the second embodiment is to be opened from the left side as viewed from the operator. FIG. 11 is a rear view of the door body 7.

First, in the state shown in FIG. 10, the opening/closing lever 54 is rotated in the counterclockwise direction, as indicated by an arrow with a dotted line in FIG. 10. This is the case where the operator rotates the opening/closing lever 54 in the clockwise direction as viewed from the operator.

FIG. 11 illustrates a state of the opening/closing lever 54 after having been rotated.

By the rotation, the opening/closing lever 54 moves downward the rotating shaft 51 connected thereto, and moves upward the rotating shaft 52 connected thereto. As a result, the rotating shaft 51 is disengaged from the bearing section 6 in the rack body 2. The rotating shaft 52 is also disengaged from the bearing section 6 in the rack body 2. In this state, the opening/closing lever 54 becomes locked. As a result, the rotating shafts 51 and 52 also become locked. By the rotation, the opening/closing lever 54 depresses the lock bar 71 connected to the rotating shaft 51. Consequently, within a hole section 72 of the lock bar 71, a protrusion section 73 of the rotating shaft 51 slides from the right end of the hole section 72 toward the left side, and stops at the left end thereof.

In this state, the lock bar 71 is inhibited by the protrusion section 73, and cannot slide toward the right direction, so that the rotating shaft 61 connected to the lock bar 71, and the opening/closing lever 64 connected to the rotating shaft 61 are inhibited from clockwise rotation.

As a consequence, the rotating shafts 61 and 62 serve as a shaft for rotating the door 4 from the left side as viewed from the operator. When the operator pulls forward the opening/closing lever 54, the door body 7 opens from the left side.

Next, description is made of operations when the door 4 that has been opened from the left side is to be closed.

First, the operator rotates the door 4 and accommodates it within the rack body 2. Then, the operator rotates the opening/closing lever 54 in the counterclockwise direction as viewed from the operator. In FIG. 11, since the opening/closing lever 54 rotates clockwise, it moves upward the rotating shaft 51 connected thereto, and moves downward the rotating shaft 52 connected thereto. As a result, the rotating shaft 51 is inserted into the bearing section 6 in the rack body 2. The rotating shaft 52 is also inserted into the bearing section 6 in the rack body 2.

Simultaneously, the opening/closing lever 54 pushes up the lock bar 71. Consequently, the protrusion section 73 of the rotating shaft 51 slides within the hole section 72 up to the right end thereof. The lock bar 71 returns to the stoppage position. This results in a state where the door body 7 is closed.

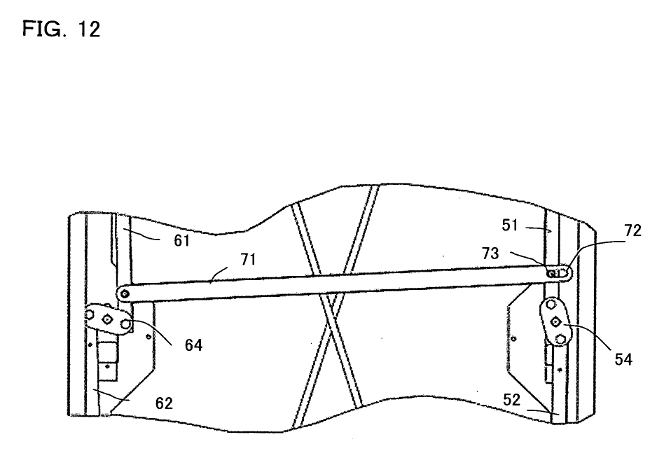

FIG. 12 is a diagram of operations when the door according to the second embodiment is to be opened from the right side as viewed from the operator.

First, in the state shown in FIG. 10, the opening/closing lever 64 is rotated in the clockwise direction, as indicated by a dotted line with an arrow in FIG. 10. This is the case where the operator rotates the opening/closing lever 64 in the counterclockwise direction as viewed from the operator.

By this rotation, the opening/closing lever 64 moves downward the rotating shaft 61 connected thereto, and moves upward the rotating shaft 62 connected thereto. As a result, the rotating shaft 61 is disengaged from the bearing section 6 in the rack body 2. The rotating shaft 62 is also disengaged from the bearing section 6 in the rack body 2.

Simultaneously, the opening/closing lever 64 depresses the lock bar 71. As a consequence, the protrusion section 73 of the rotating shaft 51 slides within the hole section 72 of the lock bar 71, and stops at the left end of the hole section 72.

In this state, even when attempting to rotate the opening/closing lever 54 connected to the lock bar 71, the rotating shaft 61 cannot move any more, to thereby inhibit the movement of the lock bar 71, so that the opening/closing lever 54 cannot rotate.

The rotating shafts 51 and 52 serve as a shaft for opening the door body 7 from the right side as viewed from the operator. When the operator pulls forward the opening/closing lever 64, the door 4 opens from the right side.

Now, description is made of operations when the door 4 that has been opened from the right side is to be closed.

First, the operator rotates the door 4 and accommodates it within the rack body 2. Then, the operator rotates the opening/closing lever 64 in the clockwise direction as viewed from the operator. By this rotation, the opening/closing lever 64 moves upward the rotating shaft 61 connected thereto, and moves downward the rotating shaft 62 connected thereto. As a result, the rotating shaft 61 is inserted into the bearing section 6 in the rack body 2. The rotating shaft 62 is also inserted into the bearing section 6 in the rack body 2.

Simultaneously, the opening/closing lever 64 pushes up the lock bar 71. As a result, in the lock bar 71, the protrusion section 73 thereof slides within the hole section 72 from the left end to the right end thereof. Consequently, the lock bar 71 returns to the stoppage position. This results in a state where the door 4 is closed.

As shown in the above-described embodiments, since a device having a rack with a door structure for opening from both of the left and right sides is less in limitations in installing the device, maintenance performance and work efficiency thereof can be enhanced.

The foregoing descriptions have been made of a rack and its door used for a disk array device, but besides, the present invention is also applicable to a rack and its door for other information processing devices such as a server.

What is claimed is:

1. A door for opening/closing a rack body accommodating an electronic device, the door comprising:
a door body;
a pair of rotating shafts for rotating the door body toward either one of the left and right directions, the pair of rotating shafts being provided on each of the left and right sides of the door body, the pair of rotating shafts being vertically slidable;
a pair of opening/closing levers provided on each of the left and right sides of the door body, the opening/closing lever being connected to the rotating shaft on the same side of the door body, the opening/closing lever acommodating the connected rotating shaft within the door body by rotation; and
an inhibiting member for inhibiting one of the rotating shafts from being accommodated within the door body by operating simultaneously with rotation of the opening/closing lever connected to the other rotating shaft.

2. The door according to claim 1,
wherein the inhibiting member comprises:
a pair of rotating members that extend from a central position of the door body to the left and right sides in a horizontal direction, wherein first ends of the rotating members are disposed adjacently along rotating directions of the respective opening/closing levers, and second ends of the rotating members are disposed adjacently to a position where the pair of rotating members make contact with each other under rotation; and
a pair of rotation support sections for supporting rotation of the respective rotating members,
wherein, by rotation of one of the opening/closing levers, the one of the rotating members adjacent to the one of the opening/closing levers is depressed, rotated, and fixed, whereby rotation of the other rotating member and rotation of the other opening/closing lever adjacent to the other rotating member are inhibited.

3. The door according to claim 1,
wherein the inhibiting member further comprises a connection member that is connected to the left and right rotating shafts; and
wherein, by the rotation of the one of the opening/closing levers, one end of the connection member connected to the rotating shaft on one side is rotated with the other end of the connection member as a fulcrum, and is fixed, whereby rotation of the rotating shaft on the other side connected to the other end of the connection member, and rotation of the other of the opening/closing levers connected to the rotating shaft on the other side is inhibited.

4. The door according to claim 3, wherein a groove is provided in one end of the connection member, and a protrusion section that is to be engaged with the groove is provided in the rotating shaft corresponding to the one end side of the connection member, whereby the connection member rotates by the protrusion section sliding within the groove under rotation of the opening/closing lever.

5. The door according to claim 4, wherein, in the pair of opening/closing levers, one of the pair is opposite in opening/closing direction to the other of the pair.

6. A rack comprising:
a rack body that accommodates an electronic device, and
a door for opening/closing the rack body, the door being engaged with the rack body at predetermined positions, the door comprising:
a door body;
a pair of rotating shafts for rotating the door body toward either one of the left and right directions, the pair of rotating shafts being provided on each of the left and right sides of the door body, the pair of rotating shafts being vertically slidable;
a pair of opening/closing levers provided on each of the left and right sides of the door body, the opening/closing lever being connected to the rotating shaft on the same side of the door body, the opening/closing lever acommodating the connected rotating shaft within the door body by rotation; and
an inhibiting member for inhibiting one of the rotating shafts from being accommodated within the door body, the inhibiting member operating simultaneously with the rotation of the opening/closing lever connected to the other rotating shaft.

7. The rack according to claim 6,
wherein the inhibiting member comprises:
a pair of rotating members that extend from a central position of the door body to the left and right sides in a horizontal direction, wherein first ends of the rotating members are disposed adjacently along rotating directions of the respective opening/closing levers, and second ends of the rotating members are disposed adjacently to a position where the pair of rotating members make contact with each other under rotation; and
a pair of rotation support sections for supporting rotation of the respective rotating members,
wherein, by rotation of one of the opening/closing levers, the one of the rotating members adjacent to the one of the opening/closing levers is depressed, rotated, and fixed, whereby rotation of the other rotating member and rotation of the other opening/closing lever adjacent to the other rotating member are inhibited.

8. The rack according to claim 6,
wherein the inhibiting member further comprises a connection member that is connected to the left and right rotating shafts; and
wherein, by the rotation of the one of the opening/closing levers, one end of the connection member connected to the rotating shaft on one side is rotated with the other end of the connection member as a fulcrum, and is fixed, whereby rotation of the rotating shaft on the other side connected to the other end of the connection member, and rotation of the other of the opening/closing levers connected to the rotating shaft on the other side is inhibited.

9. The rack according to claim 8, wherein a groove is provided in one end of the connection member, and a protrusion section that is to be engaged with the groove is provided in the rotating shaft corresponding to the one end side of the connection member, whereby the connection member rotates by the protrusion section sliding within the groove under rotation of the opening/closing lever.

10. The rack according to claim 9, wherein, in the pair of opening/closing levers, one of the pair is opposite in opening/closing direction to the other of the pair.
